(19) United States
(12) Patent Application Publication
(10) Pub. No.: US 2004/0186799 A1
(43) Pub. Date: Sep. 23, 2004

(54) Voucher processing

(76) Inventors: Charles Dunn, New South Wales (AU); Brian Squires, Victoria (AU)

Correspondence Address: MORGAN & FINNEGAN, L.L.P., 345 PARK AVENUE, NEW YORK, NY, 10154, US

(21) Appl. No.: 10/486,019

(22) PCT Filed: Sep. 27, 2002
(86) PCT No.: PCT/AU02/01322

(30) Foreign Application Priority Data
Oct. 8, 2001 (AU) PR 8115

(51) Int. Cl. G06F 17/60

(52) U.S. Cl. 705/30

(57) ABSTRACT

This invention concerns a method for processing cheque and deposit vouchers by a financial institution (Proof of Deposit). The method involves an operator preparing vouchers for feeding into a machine reader. Capturing an image from the voucher. Correcting incorrectly read scan lines. Automatically notifying the operator when a transaction boundary is detected and suspending processing of vouchers until the transaction is manually balanced. Finalising processing of each voucher by printing captured and trace details on each voucher.

### TECHNICAL FIELD

This invention concerns a method for processing cheque and deposit vouchers by a financial institution.

### BACKGROUND ART

Processing of cheques and other vouchers by many financial institutions involves a manual process enhanced by computers and machine readers. A reliable process adopted by many financial institutions is as follows:

1. A team of trained staff prepare the cheques and deposit vouchers for presentation to a large, high speed, machine reader (transport).

2. The cheques and deposit vouchers are then presented to the transport which lifts an image of the cheques and deposit vouchers.

3. Some of the scan line details, that is the preprinted MICR lines, are typically unable to be read or are incorrectly read, and another team of trained staff then enter correct the details by entering corrections at workstations separate from the transport, by reading the cheques and deposit vouchers and comparing them to the captured images.

4. A further team of trained staff key in the dollar values associated with the cheques and deposit vouchers at workstations separate from the transport, by reading the images captured by the transport

5. A still further team of trained staff balance each transaction which are made up of a series of debits and credits which must have a net value of zero.

6. Once all of the above steps are complete the items are presented to the transport a second time. The MICR information is read and matched back to information previously read or keyed. The additional information keyed is then used to complete the processing of the item. This includes printing the value amount along with trace details on the rear of the item and a ‘not negotiable’ stamp on the front Items are sorted based on predefined criteria for subsequent internal processing or alternately presentation to the source bank.

### SUMMARY OF THE INVENTION

The invention is a method for processing cheque and deposit vouchers by a financial institution, comprising the following steps:

An operator preparing vouchers for feeding into a machine reader (transport);

Presenting the vouchers to the transport to capture an image from the voucher;

The operator correcting incorrectly read scan lines, such as the preprinted MICR lines, by viewing the vouchers in transport and entering corrected data;

Automatically notifying the operator when a transaction boundary is detected and suspending processing of vouchers until the transaction is manually balanced;

Finalising processing of each voucher by printing the amount on the item along with trace details on the rear of the item and a ‘not negotiable’ stamp on the front.

Usually to processing is followed by sorting vouchers using predefined criteria for further action or presentation to their source banks.

This process enjoys a number of advantages compared with the known process, namely:

Since it is not necessary to use large monolithic transports, but low or medium speed transports are sufficient, the process is easily scalable. Also, since the same operator is able to perform all the steps in the processing of vouchers, more effective use of labour is possible. It is also only necessary for each voucher to be presented to the transport once.

The use of this approach means that considerable savings may be realised in terms of CAPEX and associated equipment maintenance. Also an effective reduction in the number of FTE's required of up to 30% can be achieved.

### BRIEF DESCRIPTION OF THE DRAWINGS

An example of the invention will now be described with reference to the accompanying drawings, in which:

FIG. 1 is a block diagram of the hardware/software of the voucher processing system.

FIG. 2 is a process flow diagram of the voucher processing.

FIG. 3 is a screen design of the voucher processing system in the edit window.

### BEST MODES OF THE INVENTION

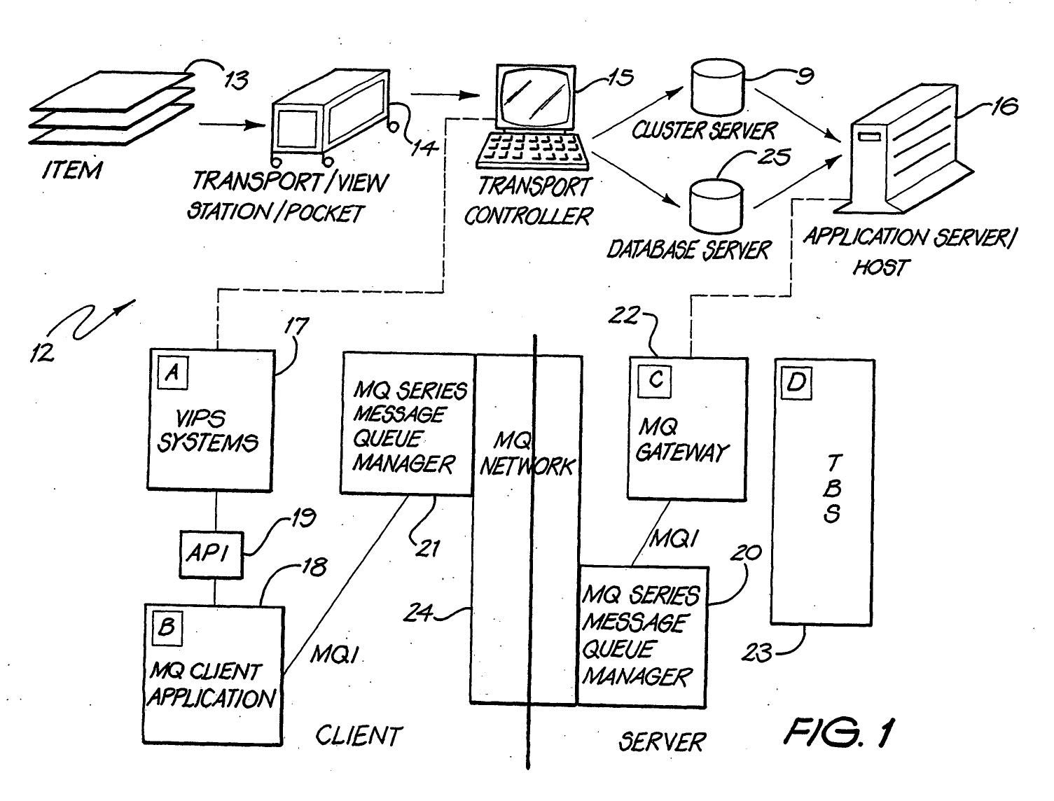

Referring to FIG. 1, the voucher processing system 12 comprises of a Microsoft NT Server 16 located at each processing site, to be used as an application server for consolidation and management. The Microsoft NT Server 16 connects a cluster server 9 and database server 25 at a processing site for voucher data handling. There is at least one Microsoft Workstation 15 connecting to the cluster and database servers for the administration of data collected from the vouchers and control of at least one Rototype CBX 6000 transport 14.

Software residing on the Workstation 15 includes the Transport Manager Application or voucher processing system 17 and connectivity software such as the Messaging and Queueing (MQJ client 18, MQ-Application Program Interface (MQ-API) 19 and Queue Manager software 21. The MQ-API is used for interfacing between the voucher processing system 17 and MQ client 18. The Queue Manager 21 is used for the management of messages sent from client to the server. Software residing on Microsoft NT server 16 include the MQ Server program Queue Manager 20 to manage the messages arriving and departing the server and the MQ gateway 22 which is used to hide the complexity of MQ from TBS 23. Communication between MQ-Client 18 and MQ-Server 20 is facilitated by MQ-API 19 allowing voucher data records from the Transport Manager Application 17 to reach Microsoft NT server 16.

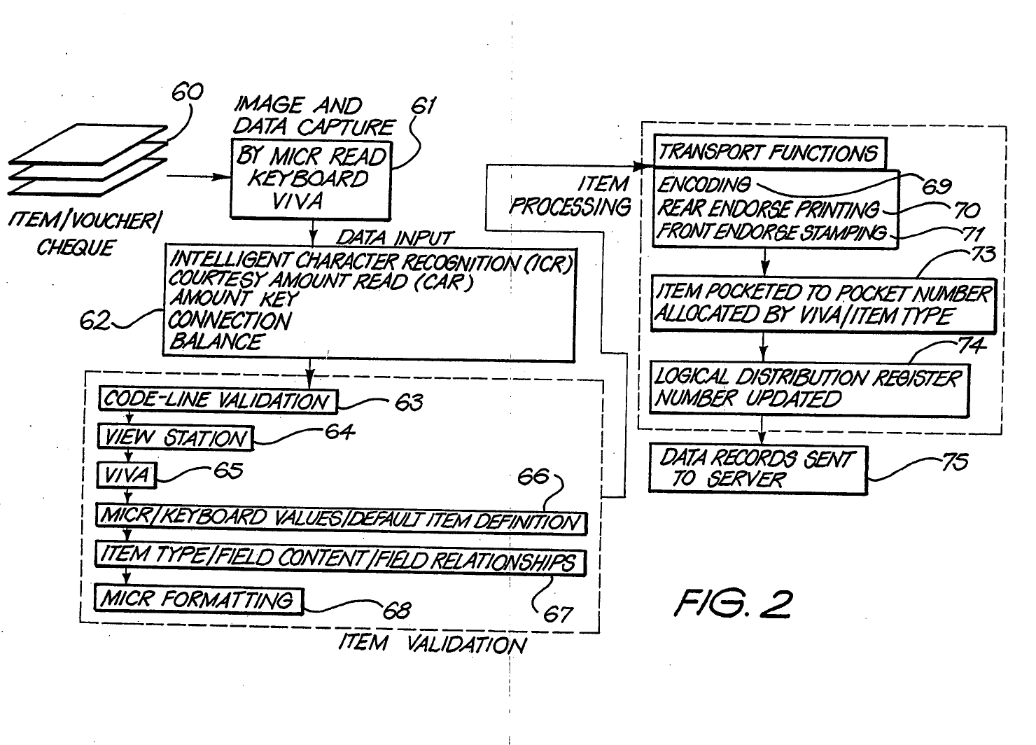

Referring to FIG. 2, in a typical scenario, a human operator feeds a cheque 60 onto the Manual hopper of the Rototype where data and image capture 61 of the cheque occurs. A data record of the cheque is created containing fields of data relating to the cheque. The data captured is supplemented by data input 62 performed by the operator to include amounts, balancing figures and preliminary correction to the captured data. The data is validated through code line validation 63 prior to the cheque passing through the view station 64. Further validation is performed by a software component that maintains default item definitions and defines validation procedures on the cheques called VIVA 65. Magnetic Ink Character Recognition (MICR), keyboard values, default item definitions 66 are all checked, followed with checking of item type, field context and field relationships 67. MICR formatting 68 is also validated prior to the cheque proceeding to item processing. Once validation has been successful transport functions such as encoding 69, rear endorse printing 70 and front endorse stamping 71 are applied to the cheque. Once these functions have been performed, the cheque is pocketed to a pocket number allocated by VIVA 73 according to its item type. The physical processing of the cheque has completed but further handling of the captured data occurs. The logical distribution register number 74 is updated in the voucher processing system software. At determined intervals, the data records are sent to the Host server 75 for consolidation and bank usage.

In further detail, at the data capture 61 stage, the Rototype reads the pre-encoded fields on the surface of the cheque. The Rototype is equipped with a single front reader capable of reading MICR characters in E13B font, a view station 64 and twelve pockets. The MICR reader will capture pre-encoded field data present on the cheque as well as subsequently capturing an image of the front and rear of the cheque. Captured data is displayed on the view station for review by an operator. As a result the operator may make keyboard entries via the Workstation's 15. Any fields that have been entered by keyboard at the Data Input bar 51 in the Edit Window by the operator are combined with the captured data to form the item code-line. Notification of missing or invalid item code line data is prompted through alarms and dialogue boxes displayed on the screen. The operator has to key the missing or valid data via the Workstation 15. The Rototype ceases further processing of any cheques until the operator has resolved the error. Editor modules provide the interaction between the operator and the Workstation 15 for correction and balancing of transaction based-batches and include work navigation engines and a validation engine. Work navigation engines include the screen display for editing cheque data after it has been captured and specialised keyboards for specific commands relating to cheques.

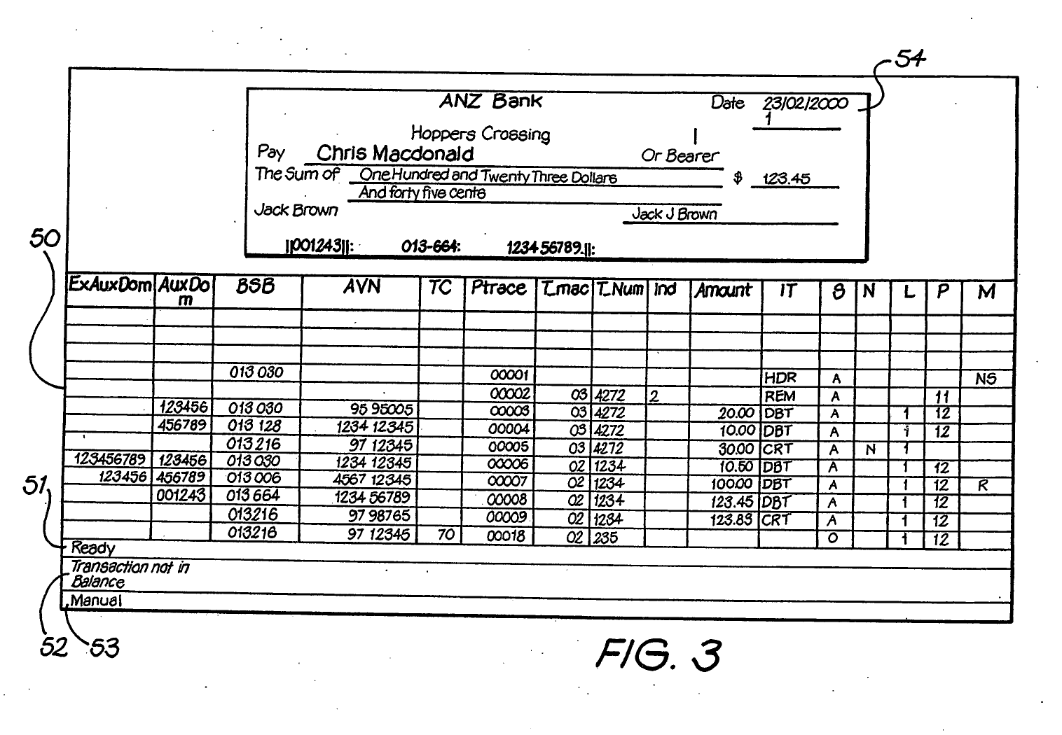

FIG. 3 shows an edit window including the captured image of the cheque is. Referring to FIG. 3, the standard screen layout will have:

The Menu Options located at the top of screen;

The Edit window Spreadsheet 50 utilising the majority of the processing screen;

The Data Input bar 51 directly below the Edit Window Spreadsheet 50;

The Edit Window Status bar 52 directly below the Data Input bar 51;

The Application Status bar 53 directly below the Edit window status bar 52 at the bottom of the screen.

The front image 54 of the captured cheque is displayed between the Menu Options and the Edit window Spreadsheet.

The Edit window Spreadsheet 50 contains data that has been captured from the cheque and also operator keyed data. This data is a subset of the voucher's final data record that will be transmitted to the banks Host system 16 for account posting. The column headings in the Edit window Spreadsheet 50 are representative of some of the fields in the data record and contains the code-line data, for example the IT column is the Item Type field. The code-line data is used to determine any validation and further processing. Field symbols in a cheque's pre-encoded data are used to identify and format the fields and then discarded.

A data record is created as each cheque passes through the Rototype and allocated a proof trace (Ptrace) number. The Ptrace number is a five digit unique number assigned sequentially to all the vouchers processed by a specific Rototype. The Rototype's identification number (Proof Trace Machine Number) and the Ptrace number (Proof Trace Sequence Number) is concatenated together to form a unique identifier for a data record.

A data record such as the voucher processing system's Data Record for Item Processing located on Workstation 15, is created and populated in the same manner regardless of whether the data originated from MICR, the keyboard or VIVA. The source of the data however, impacts on the validation of the item, for example other bank debit items can only be valid for Electronic Presentment (EP) if the data input is from the MICR. There are approximately 64 fields of data for the voucher processing system's data record and they are:

| Field | Brief Description |
|---|---|
| Batch | Batch number generated by the Workstation. |
| Trace | Trace number generated by the Workstation. |
| Sys_date | System date for the day the voucher was processed. |
| Proc_date | Application processing date, used in the endorsement line |
| | printed on the rear of the voucher to represent the business |
| | processing date. |
| Ex_aux | A numeric value depending on the voucher type. |
| Aux_dom | A numeric value depending on the voucher type. |
| BSB | Bank State Branch if present on the voucher. |
| Account | Account number if present on the voucher. |
| Trancode | A numeric value depending on the voucher type. |
| Amount | The amount value present on the voucher. |
| Prf_bsb | The Proof Site BSB containing State and Branch number. |
| Neg_bsb | The Negotiating BSB. |
| Doc_type | A 3 character abbreviation of the voucher type. |
| Src_ind | Source indicator for the voucher. |
| Dest_ind | Destination indicator. |
| Cat_val | Category Value |
| Acc_type | Account Type |
| Pt_mch | Proof Trace Machine Number, of the Rototype that |
| | processed the voucher. |
| Pt_num | Proof Trace Sequence Number, a sequential number that is |
| | incremented each time a voucher is processed. |
| t_bsb | Transaction Trace BSB, a data operator entered value. |
| t_mch | Transaction Trace Terminal Number, a data operator |
| | entered value. |
| Tt_num | Transaction Trace Sequence Number, the next sequence |
| | number generated when the Transaction Trace is generated. |
| Log_pkt | The logical pocket number for logical distribution |
| | allocation. |
| Phys_pkt | The physical pocket number for physical distribution |
| | allocation (the pocket on the Rototype) |
| Credit_amt | Remittance Voucher Credit Value |
| Debit_amt | Remittance Voucher Debit Value |
| Op_id | The human operator's ID number. |
| Sys_time | The time that the voucher was processed. |
| Rep_seq | Reporting Sequence number to identify which vouchers |
| | have already been reported on. |
| Unclear | Uncleared Funds value. |
| Rep_ind | Record Data Modification flag to indicate whether the |
| | voucher was processed automatically or required human |
| | assistance in processing. |
| Remote_ind | Remote site indicator, whether the site is a primary capture |
| | site or not. |
| Del_ind | Delayed item indicator |
| MAC | Hash/MACcode supplied by the bank. |
| Inc_ind | Inclearings indicator. |
| Rel_ind | Relist indicator |
| Job_id | The Job Type |
| Rem_ind | Rem indicator, keyed by operator for balancing. |
| Nfv_ind | Not For Value indicator |
| Let_ind | Letter Indicator, if Error Adjustment mode was used. |
| Frd_ind | Possible Fraud Indicator, for fraudulent vouchers detected. |
| Box_no | Box number. |
| Itm_lst | Keyed by operator for item list. |
| Itm_dm | Item drawn for keyed by operator. |
| Br_bsb | Cheque on, keyed by operator for use on customer letters. |
| Drawer | Cheque Drawer, keyed by operator for use on customer |
| | letters. |
| Payee | Cheque Payee, keyed by operator for use on |
| | customer letters. |
| Incl_bnk | Inclearings Bank BSB. |
| Mod_ind | Modification indicator, whether the voucher has been |
| | modified since original capture. |
| Image_ind | Indicates if an image capture exists for this voucher. |
| V_Type | A field used in validation. |
| Ns_ind | No Sort Indicator, the voucher has not been sorted or |
| | physically passed through the transport. |
| Ex_num | Exchange Number, used in relist processing. |
| MQResub | Resubmit counter, to indicate an error in the batch occurred. |
| MQErrCode | Error code that occurred for the voucher. |
| MQErrDesc | Error description for the error that occurred for the voucher. |
| MQRef | Internal reference number for voucher sent to Host. |
| Bundle | Bundle Relisted Item, increments sequentially for group |
| | items. |
| Chq_seq | Sequence number of item within each bundle. |
| MSE_Type | Determines if voucher is a Merchant Envelope. |
| AppSvrname | Name of the Server |
| Ex_date | Exchange Date |
| Held_ind | Heldover indicator, assigned to each relist item in heldover |
| | reporting. |

Record structure is ANZ's and will vary from client to client.

Following the capturing 61 and input 62 of item data, item validation commences. The MICR and keyboard entered values (including default item type definitions) 66, will be validated to identify the type of item being processed, the field content and the field relationships 67. The item type will also determine the further processing requirements of the item.

Item types include:

HDR—Branch Header documents.

DBT—Debit Items.

CRT—Credit Items.

REM—Remittance voucher.

BVD—Batch Value Header.

Item types will vary from client to client. Also terminology will be Australian. Fundamental voucher types could be referred to as debit, credit and control items.

VIVA will define validation for:

Field presence/absence

Check digit requirements

Field relationships

Field Capacity

Item input to VIVA includes:

Account type, Source and Category Codes of an item

Assigned field values

Item output from VIVA includes:

Logical and physical pocket numbers

Encode requirements and encode line formats

Endorse requirements front and rear

Rear endorse line formats

Encode/non-encode on a field by field basis

The view station 64 is located on the Rototype. Code-line validation 63 will be applied after a cheque has passed the MICR read head, but prior to the cheque reaching the view station 64. Errors in validation or MICR formatting will cause the cheque to be held in the view station 64 until the error is corrected. Any alteration or addition to the cheque at this point will cause the cheque to be re-presented for validation. Correction of errors is done by the operator through the Workstation by keying in the correct data where fields have been captured incorrectly or are invalid at the Data Input bar 51.

When a field is in error:

the Rototype will hold the cheque in the view station an operator will respond to the error message by keying the required numeric data and appropriate field terminator the cheque will then be re-presented to VIVA for validation.

This process will be repeated until all required fields are present and valid. Some field errors include:

MICR Already Present

Fraudulent Item Detection

MICR character can't reads

Missing Code-line fields

Check digit verification errors

Field Capacity errors

Invalid Code-line fields

After all validation and code-line checks have been successful for the Job Type, the cheque will be released from the view station to complete processing. Job Types include:

Proof Of Deposit, these consist of debit and credit items that form transactions

Debit Inclearings, these are host bank items received from other banks that are either excluded from or failed validation for Electronic Presentment (EP).

Credit Inclearings, these are host bank items received from other banks, similar to debit inclearings.

Debit Relist, these are other bank's items captured by the host bank that have failed EP validation at the Rototype.

Credit Relist, these are other banks items captured by the host bank, similar to debit relist.

Separation Sort, is used as a simple separation sort based on one or more MICR code-line components.

Image Lift Not For Value (NFV), captures the image and data of host bank items deposited at other banks and captured for EP.

MICR Creation, provides an operator with the ability to apply any field or combination of fields to a blank document.

Encode, generates physical items by encoding MICR from files produced during processing job types Proof of Deposit, Debit/Credit inclearings and Debit/Credit relist

The remaining processing after item validation include:

Encoding 69

Rear Endorse Printing 70

Front Endorse Stamping 71

Image Capture 72

Encoding of fields 69 other than MICR are determined according to the Job Type being processed. The default value is to apply encoding for all Job Types except Relist, image Lift NFV and Offline Fine Sort. Code-line formats will be defined as part of the validation parameters. The VIVA Item output settings determine whether a field will be encoded and the encode line format used. The encode line format will determine field location and length, fixed characters such as spaces and dashes and character fill requirements. If the data entered for a field is longer than the specified length for that field, the field will not be encoded.

The rear endorse 70 line format will determine the fields to be endorsed, field positions and fill requirements. The rear endorse line format to be applied will be assigned by VIVA as part of Item Output. Similarly again, rear endorsing is determined according to the Job Type being processed. The default value is to apply rear endorsing in all job types except Miscellaneous MICR Creation and Offline Fine Sort.

Front endorse stamping 71 or cancellation will be independent of rear endorsing lines. Its application, global and item definition controls will be separate from rear endorsing, apart from the override key which affects both front and rear endorsing. The default value is to be disabled for all Job Types except Proof of Deposit processing.

Image capture 72 requirements are defined as part of Item Output assigned by VIVA The default values for image capture are to be applied for Proof of Deposit, Inclearings, Image Lift NFV and disabled for Relist, Miscellaneous MICR Creation and Offline Fine Sort. The capturing of the image is done by the Rototype and is viewable by the operator in the Edit Window on their Workstation. It is only at this stage that the system will direct the Rototype that the whole image of the cheque must be captured not at data capture 61, where individual fields of data are being captured.

After all item processing is completed through successful completion of the above steps, the cheque is processed to pocket 73. The item count for that pocket will be incremented and updated. When the counter for a pocket reaches its warning limit, for example, 200 items, an alarm will be triggered and an error message box will be displayed. An operator will then clear the pocket of all items and index the [Debit] key to acknowledge the message and the pocket counter for that item will be reset to zero.

Also on completion of processing any individual item, the voucher processing system's will update the item count for the relevant distribution 74 to which the item was assigned. If the relevant item distribution count reaches the maximum limit for that distribution set in VIVA, then an alarm will sound and an error message box will be displayed. An operator will index the [Debit] key to acknowledge the message and the relevant item distribution counter will reset to zero.

The voucher data records are kept on Workstation 15 and transmitted 75 in batches to the Microsoft NT server 16 for account posting by the bank. Transmission of data records is facilitated through the MQ-Client 18 using MQ-Application Program Interface (MQ-API) 19 to communicate with MQ Server program Queue Manager 20.

Rejected cheques are handled efficiently and systematically in the following steps:

A misread item will be sorted to the reject pocket

Data records and images for rejected items will be deleted.

A Reject Repass occurs after all items have been fed.

On the Rototype, pocket twelve will be reserved as the Reject pocket Pockets 1-11 will accept items in a continuous loop commencing with pocket 1. Pocket 1 will fill to the threshold limit, followed by pocket 2 etc. until pocket 11 is filled, items will then sort to pocket 1 again after the pocket is cleared. The quality of paper used means minimal rejects can be expected. All code-line fields will be present on these items in MICR. The only anticipated reject cause are “can't read characters”. When “can't read characters” are detected on the original pass, the item will be sent to the reject pocket.

A Reject Repass will occur over items found in the Reject pocket When all items have been run, the operator will select the Reject repass mode by indexing [Func] [88] on the system. A confirmation message box will appear asking whether a Reject Repass will proceed for the manual match function. Pressing the [Debit] key will confirm Reject Repass mode but pressing the [Esc] key will exit the Reject Repass mode and return to the “Ready” mode. The items in the reject pocket will be loaded back into the Autofeed hopper and the items re-processed. The operator will correct the “can't read characters” by keying the field at the Data Input bar 51 in the Edit Window and indexing the field terminator. If the operator is unable to correct the problem, indexing [Esc] will reject the item.

1. A method for processing cheque and deposit vouchers by a financial institution, comprising the following steps:
an operator preparing vouchers for feeding into a machine reader, or transport;
presenting the vouchers to the transport to capture an image from the voucher;
the operator correcting incorrectly read scan lines by viewing the vouchers in transport and entering corrected data;
automatically notifying the operator when a transaction boundary is detected and suspending processing of vouchers until the transaction is manually balanced;
finalising processing of each voucher by printing captured and trace details on each voucher.

2. A method for processing cheque and deposit vouchers by a financial institution according to claim 1, comprising the further step of sorting vouchers using predefined criteria for further action or presentation to their source banks.

3. A method for processing cheque and deposit vouchers by a financial institution according to claim 1 or 2, where the same operator performs all the operator steps in the processing of vouchers.

4. A method for processing cheque and deposit vouchers by a financial institution according to claim 3, where it is only necessary for each voucher to be presented to the transport once.
